(19) United States
(12) Patent Application Publication
(10) Pub. No.: US 2007/0070243 A1
(43) Pub. Date: Mar. 29, 2007

(54) Adaptive vertical temporal flitering method of de-interlacing

(75) Inventor: Jian Zhu, Tangjia (CN)

Correspondence Address: BRUCE H. TROXELL, SUITE 1404, 5205 LEESBURG PIKE, FALLS CHURCH, VA, 22041, US

(73) Assignee: ALi Corporation

(21) Appl. No.: 11/236,643

(22) Filed: Sep. 28, 2005

(51) Int. Cl. H04N 11/20

(52) U.S. Cl. 348/448

(57) ABSTRACT

An adaptive vertical temporal filtering method of de-interlacing is disclosed, which is capable of interpolating a missing pixel of an interlaced video signal by a two-field VT filter while compensating the de-interlaced result adaptively with respect to the characteristics of edge defined by the vertical neighbors of the missing pixel. Furthermore, the method of the invention is enhanced with greater immunity to noise and scintillation artifacts than is commonly associated with prior art solutions.

### FIELD OF THE INVENTION

The present invention relates to an adaptive vertical temporal filtering method of de-interlacing, and more particularly, to a two-field de-interlacing method with edge adaptive compensation and noise reduction abilities.

### BACKGROUND OF THE INVENTION

In this era of digital video and as the video industry transitions from analog to digital, viewers pay much more attention to image quality. The old interlaced-video standards no longer meet the quality levels that many viewers demand. De-interlacing offers a way to improve the look of interlaced video. Although converting one video format to another can be relatively simple, keeping the on-screen images looking good is another matter. With the right de-interlacing techniques, the resulting image is pleasing to the eye and devoid of annoying artifacts.

Despite the resolution of digital-TV-transmission standards and the market acceptance of state-of-the-art video gear, a staggering amount of video material is still recorded, broadcast, and retrieved in the ancient interlaced formats. In an interlaced video signal format, only half the lines that comprise full image are transmitted during each scan field. Thus, during each scan of the television screen, every other scan line is transmitted. Specifically, first the odd scan lines are transmitted and then the even scan lines are transmitted in an alternating fashion. The two fields are interlaced together to construct a full video frame. In the American National Television Standards Committee (NTSC) television format, each field is transmitted in one sixtieth of a second. Thus, a full video frame (an odd field and an even field) is transmitted each one thirtieth of a second.

In order to display an interlaced video signal on a digital TV or computer monitor, the interlaced video signal must be de-interlaced. De-interlacing consists of filling in the missing even or odd scan lines in each field such that each field becomes a full video frame.

The two most basic linear conversion techniques are called “Bob” and “Weave”. “Weave” is the simpler of the two methods. It is a linear filter that implements pure temporal interpolation. In other words, the two input fields are overlaid or “woven” together to generate a progressive frame; essentially a temporal all-pass. While this technique results in no degradation of static images, moving edges exhibit significant serrations referring as “feathering”, which is an unacceptable artifact in a broadcast or professional television environment.

“Bob”, or spatial field interpolation, is the most basic linear filter used in the television industry for de-interlacing. In this method, every other line (one field) of the input image is discarded, reducing the image size from 720×486 to 720×243 for instance. The half resolution image is then interpolated back to 720×486 by averaging adjacent lines to fill in the voids. The advantage of this process is that it exhibits no motion artifacts and has minimal compute requirements. The disadvantage is that the input vertical resolution is halved before the image is interpolated, thus reducing the detail in the progressive image.

The aforesaid linear interpolators work quite well in the absence of motion, but television consists of moving images, so more sophisticated methods are required. The field-weave method works well for scenes with no motion, and the field interpolation method is a reasonable choice if there is high motion. Non-linear techniques, such as motion adaptive de-interlacing, attempt to switch between methods optimized for low and high motion. In motion adaptive de-interlacing, the amount of inter-field motion is measured and used to decide whether to use the “Weave” method (if no inter-field motion detected), or the “Bob” method (if significant motion detected), that is, to manage the trade-off between the two methods. However, it is general that an image might contain both moving objects and still objects. While de-interlacing a video signals of a moving object moving toward a still object by an motion adaptive de-interlacing method, the “Bob” method is usually preferred since feathering effect caused by “Weave” is more obvious and intolerable, but it will adversely reduce the details of the still object, especially the edge of the still object approached by the moving object that part of or all of the edge is affected thereby and form a broken line.

In order to improve the motion adaptive de-interlacing of video signal containing still and moving objects, a vertical temporal (VT) filter combining the linear spatial and linear temporal methods is adopted, which can alleviate the extend of edge to be damaged by using “Bob” while preserving the edge of the still object without introducing feathering effect.

Please refer to FIG. 1, which illustrates the aperture of a conventional three-field VT filter. The vertical position is indicated on the vertical axis, while the field number is indicated on the horizontal axis. The black dots P2, P3, . . . , P8, indicate original samples while the open circle PI indicates an interpolated sample to be obtained. As seen in FIG. 1, the missing pixel represented by the open circle PI is derived from the four spatial neighbors P5, P6, P7, P8 and the three temporal neighbors P2, P3, P5, that is,

$$P 1 = \{ \begin{matrix}[ P 2 \times ( - 5 ) + P 3 \times 10 + P 4 \times ( - 5 ) ] + \\ \frac{1}{18} [ P 6 \times 8 + P 7 \times 8 + P 5 \times 1 + P 8 \times 1 ]\end{matrix} \} ,$$

which is obtained by physically filtering the temporal neighboring field of n−1 by a high-pass filter and filtering the current field of n by a low-pass filter. Nevertheless, the vertical temporal filter of prior-art will create echoes that forms unwanted false profiles outlining the moving objects which are preferred to be removed. In addition, it is generally considered that edges of the still objected can be better preserved if the VT filter is well adapted accordingly.

Therefore, it is needed to have a VT filter with edge adaptive compensation ability for interlacing an interlaced video signal of moving and still objects, which is robust and computational efficient.

### SUMMARY OF THE INVENTION

It is the primary object of the present invention is to provide an adaptive vertical temporal filtering method of de-interlacing, which is capable of interpolating a missing pixel of an interlaced video signal by a two-field VT filter while compensating the de-interlaced result adaptively with respect to the characteristics of edge defined by the vertical neighbors of the missing pixel. Furthermore, the method of the invention is enhanced with greater immunity to noise and scintillation artifacts than is commonly associated with prior art solutions.

To achieve the above object, the present invention provide an adaptive vertical temporal filtering method of de-interlacing, which comprises the steps of:
performing a process of VT filtering on an interlaced video signal to obtain a filtered video signal;
performing a process of edge adaptive compensation on the filtered video signal to obtain an edge-compensated video signal;
performing a process of noise reduction on the edge-compensated video signal.

In a preferred aspect of the invention, the process of VT filtering further comprise the step of: interpolating a missing pixel of a current field of the interlaced video signal by using a vertical temporal filter and thereby obtaining an interpolated pixel, whereas the vertical temporal filer can be a two-filed vertical temporal filter, comprising a spatial low-pass filter of two-tap design and a temporal high-pass filter.

In a preferred aspect of the invention, the process of edge adaptive compensation further comprises the steps of:
making an evaluation to determine whether the interpolated pixel is classified as a first edge with respect to vertical neighboring pixels;
making an evaluation to determine whether the interpolated pixel is classified as a second edge with respect to vertical neighboring pixels;
making an evaluation to determine whether the interpolated pixel is classified as a median portion;
making an evaluation to determine whether the interpolated pixel classified as the first edge is a strong edge;
making an evaluation to determine whether the interpolated pixel classified as the first edge is a weak edge;
making an evaluation to determine whether the interpolated pixel classified as the second edge is the strong edge;
making an evaluation to determine whether the interpolated pixel classified as the second edge is the weak edge;
performing a first strong compensation process on the interpolated pixel classified as the first and the strong edge;
performing a second strong compensation process on the interpolated pixel classified as the second and the strong edge;
performing a first weak compensation process on the interpolated pixel classified as the first and the weak edge;
performing a second weak compensation process on the interpolated pixel classified as the second and the weak edge; and
performing an conservative compensation process on the interpolated pixel classified as median portion.

In a preferred aspect of the invention, the process of noise reduction further comprises the steps of:
making an evaluation to determine whether the interpolated pixel is abrupt with respect to its neighboring pixels; and
replacing the interpolated pixel with the value of a Bob operation performed on the neighboring pixels of the interpolated pixel on the current field while the interpolated pixel is abrupt.

For clarity, pixels in the current field is identified using a two dimensional coordinate system, i.e. X axis being used as the horizontal 20 coordinate while Y axis being used as the vertical coordinate, so that the value of a pixel at (x, y) location of the VT-filtered current field is denoted as Outputᵥₜ(x, y) while the original input value of the pixel at (x, y) location is denoted as Input(x, y), whereas BOB(x, y) represents the value of an Bob operation applied on the (x, y) location of the current field. In an preferred embodiment of the invention, the first strong compensation process further comprises the steps of:
classifying an interpolated pixel at (x, y) position as the first edge while Input (x, y) satisfies the condition of:
   Outputᵥₜ(x.y)>Input(x, y−1) & & Outputᵥₜ(x.y)>Input(x, y+1)
classifying the interpolated pixel of first edge as the strong edge while Input (x,y) satisfies the condition of:
   Input(x.y)>Input(x, y−1)>Input(x, y−2) & &
   Input(x.y) >Input(x, y+1)>Input(x, y+1);
comparing the original input value of the pixel at (x, y) location, i.e. Input(x, y), to a corresponding pixel positioned at the same location of an adjacent frame, being denoted as Input′(x, y);
replacing the interpolated pixel by the original input data thereof, i.e. Input(x, y), while the absolute difference of the original input data and the corresponding pixel is smaller than a first threshold represented as SFDT; and
replacing the interpolated pixel with a larger value selected from the group of (Input(x, y−1), Input(x, y+1)) while the absolute difference of the original input data and the corresponding pixel is not smaller than a first threshold represented as SFDT.

Preferably, the second strong compensation process further comprises the steps of:
classifying the interpolated pixel as the second edge while Input (x, y) satisfies the condition of:
   Outputᵥₜ(x.y)<Input(x, y−1) & & Outputᵥₜ(x.y)<Input(x, y+1);
classifying the interpolated pixel of second edge as the strong edge while Input (x,y) satisfies the condition of:
   Input(x.y)<Input(x, y−1)<Input(x, y−2) & &
   Input(x.y)<Input(x, y+1)<Input(x, y+1);
comparing the original input value of the pixel at (x, y) location, i.e. Input(x, y), to a corresponding pixel positioned at the same location of an adjacent frame, being denoted as Input′(x, y);
replacing the interpolated pixel by the original input data thereof, i.e. Input(x, y), while the absolute difference of the original input data and the corresponding pixel is smaller than a first threshold represented as SFDT; and
replacing the interpolated pixel with a smaller value selected from the group of (Input(x, y−1), Input(x, y+1)) while the absolute difference of the original input data and the corresponding pixel is not smaller than a first threshold represented as SFDT.

Preferably, the first weak compensation process further comprises the steps of:
classifying the interpolated pixel of fist edge as the weak edge while the condition of:
   Input(x.y)>Input(x, y−1)>Input(x, y−2) & &
   Input(x.y)>Input(x, y+1)>Input(x, y+1)
is not satisfied;
making an evaluation to determine whether a first condition of:
   Input(x.y)>Input(x, y−1) & & Input(x.y)>Input(x, y+1) & &
   Input(x.y−1)+LET>Input(x.y−2) & & Input(x.y+1)+LET>Input(x.y+2)
is satisfied; wherein LET represents the value of a second threshold;
making an evaluation to determine whether the absolute difference of Input(x, y−1) and Input(x, y+1) is larger than a third threshold represented as DBT while the first condition is not satisfied;
replacing the interpolated pixel with a value of the sum of ½ Input(x.y−1) and ½ Input(x.y+1) while the absolute difference of Input(x, y−1) and Input(x, y+1) is not larger than the DBT as the first condition is not satisfied;
replacing the interpolated pixel with a larger value selected from the group of (Input(x, y−1), Input(x, y+1)) while the absolute difference of Input(x, y−1) and Input(x, y+1) is larger than the DBT as the first condition is not satisfied;
comparing the original input value of the pixel at (x, y) location, i.e. Input(x, y), to a corresponding pixel positioned at the same location of an adjacent frame, being denoted as Input′(x, y), and simultaneously to both of the two horizontal neighboring pixels while the first condition is satisfied;
replacing the interpolated pixel with a larger value selected from the group of (Input(x, y−1), Input(x, y+1)) while the absolute difference of the original input data and the corresponding pixel is not smaller than a fourth threshold represented as LFDT and the absolute difference of the interpolated pixel and any of the two horizontal neighboring pixels is not smaller than a fifth threshold represented as LADT as the first condition is satisfied; and
replacing the interpolated pixel by the original input data thereof, i.e. Input(x, y), while the absolute difference of the original input data and the corresponding pixel is smaller than the LFDT and the absolute difference of Input(x, y) and any of the two horizontal neighboring pixels is smaller than the LADT as the first condition is satisfied.

Preferably, the second weak compensation process further comprises the steps of:
classifying the interpolated pixel of fist edge as the weak edge while the condition of:
   Input(x.y)<Input(x, y−1)<Input(x, y−2) & &
   Input(x.y)<Input(x, y+1)<Input(x, y+1)
is not satisfied;
making an evaluation to determine whether a second condition of:
   Input(x.y)<Input(x, y−1) & & Input(x.y)<Input(x, y+1) & &
   Input(x.y−1)<LET+Input(x.y−2) & & Input(x.y+1)<LET+Input(x.y+2)
is satisfied; wherein LET represents the value of the second threshold;
making an evaluation to determine whether the absolute difference of Input(x, y−1) and Input(x, y+1) is larger than the third threshold represented as DBT while the second condition is not satisfied;
replacing the interpolated pixel with a value of the sum of ½ Input(x.y−1) and ½ Input(x.y +1) while the absolute difference of Input(x, y−1) and Input(x, y+1) is not larger than the DBT as the second condition is not satisfied;
replacing the interpolated pixel with a smaller value selected from the group of (Input(x, y−1), Input(x, y+1)) while the absolute difference of Input(x, y−1) and Input(x, y+1) is larger than the DBT as the second condition is not satisfied;
comparing the original input value of the pixel at (x, y) location, i.e. Input(x, y), to a corresponding pixel positioned at the same location of an adjacent frame, being denoted as Input′(x, y), and simultaneously to both of the two horizontal neighboring pixels while the second condition is satisfied;
replacing the interpolated pixel with a smaller value selected from the group of (Input(x, y−1), Input(x, y+1)) while the absolute difference of the original input data and the corresponding pixel is not smaller than the fourth threshold represented as LFDT and the absolute difference of the original input data and any of the two horizontal neighboring pixels is not smaller than the fifth threshold represented as LADT as the second condition is satisfied; and
replacing the interpolated pixel by the original input data thereof, i.e. Input(x, y), while the absolute difference of Input(x, y) and Input′(x, y) is smaller than the LFDT and the absolute difference of Input(x, y) and any of the two horizontal neighboring pixels is smaller than the LADT as the second condition is satisfied.

Preferably, the conservative compensation process further comprises the steps of:
classifying the interpolated pixel as the median portion while the condition of:
   Input(x.y)>Input(x, y−1) & & Input(x.y)>Input(x, y+1) and
   Input(x.y)<Input(x, y−1) & & Input(x.y)<Input(x, y+1) is not satisfied;
making an evaluation to determine whether a third condition of:
   abs(Input(x, y−2)−Input(x, y+2))>ECT & &
   abs(Input(x, y−2)−Input(x, y−1))>MVT & & is satisfied;
   abs(Input(x, y+1)−Input(x, y+2))>MVT
   where ECT is the value of a sixth threshold
      MVT is the value of a seventh threshold
comparing the original input value of the pixel at (x, y) location, i.e. Input(x, y), to a corresponding pixel positioned at the same location of an adjacent frame, being denoted as Input′(x, y), while the third condition is satisfied;
replacing the interpolated pixel with the sum of half the value of the interpolated pixel and half of the value of the corresponding pixel of an adjacent field next to the current field while the absolute difference of Input(x, y) and Input′(x, y)is smaller than a tenth threshold represented as MFDT as the third condition is satisfied;
maintaining the interpolated pixel while the absolute difference of Input(x, y) and Input′(x, y) is not smaller than a tenth threshold represented as MFDT as the third condition is satisfied;
calculating a parameter referred as BobWeaveDiffer to be the absolute difference between BOB(x, y) and Input(x, y) while the third condition is not satisfied;
comparing the BobWeaveDiffer to a eighth threshold represented as MT1;
replacing the interpolated pixel with the sum of ½ BOB(x.y) and ½ Input(x.y) while the BobWeaveDiffer is smaller than the MT1;
comparing the BobWeaveDiffer to a ninth threshold represented as MT2 while the BobWeaveDiffer is not smaller than the MT1;
replacing the interpolated pixel with the sum of ⅓ Input(x.y−1) ⅓ Input(x.y), and ⅓ Input(x.y+1) while the BobWeaveDiffer is smaller than the MT2 as the BobWeaveDiffer is not smaller than the MT1; and
maintaining the interpolated pixel while the BobWeaveDiffer is not smaller than the MT2 as the BobWeaveDiffer is not smaller than the MT1;

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 illustrates an aperture of a conventional three-field VT filter.

FIG. 2 is a functional block diagram of an adaptive vertical temporal filtering method according to the present invention.

FIG. 3 illustrates a two-filed vertical temporal filter comprising a spatial low-pass filter of two-tap design and a temporal high-pass filter according to the present invention.

FIG. 4A FIG. 4B and FIG. 4C illustrate a flowchart depicting a process of edge adaptive compensation of the adaptive vertical temporal filtering method according to a preferred embodiment of the present invention.

FIG. 5 is a schematic diagram illustrating a process unit of the noise reduction process according to the present invention

FIG. 6 is a flowchart illustrating the noise reduction process on the edge-compensated result according to the present invention.

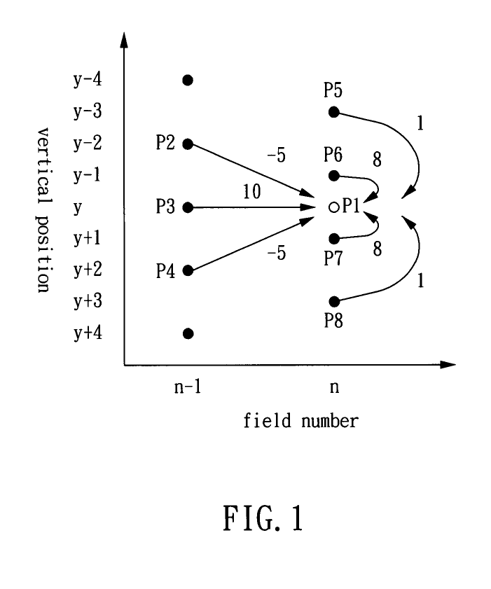

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

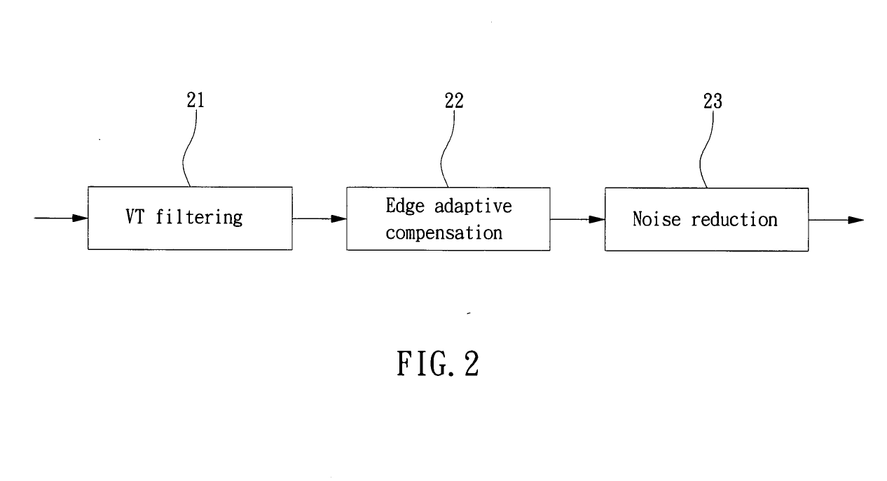

Please refer to FIG. 2, which is a functional block diagram of an adaptive vertical temporal filtering method according to the present invention. As seen in FIG. 2, an adaptive vertical temporal filtering method of de-interlacing comprises three successive stages, which are a VT filtering 21 stage, for performing a process of VT filtering on an interlaced video signal to obtain a filtered video signal; an edge adaptive compensation stage 22, for performing a process of edge adaptive compensation on the filtered video signal to obtain an edge-compensated video signal; and a noise reduction stage 23, for performing a process of noise reduction on the edge-compensated video signal.

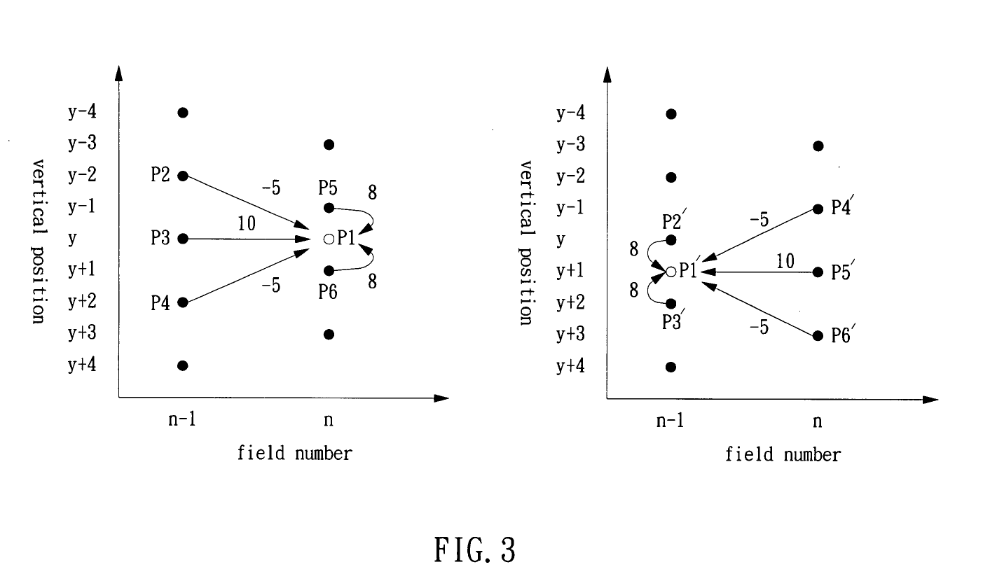

At the vertical temporal filtering stage 21, instead of using a common three-field vertical temporal filter, a two-field vertical temporal filter is used. A de-interlacing applying a three-field VT filter requires the fields processed thereby to be arranged in proper order with respect to time, in that, since three properly ordered fields of pixels with known values must be available at the same time for the de-interlacing, consequently, any posterior scheme such as the decoding of DVD or STB, etc, which employs three frame buffer, are complicated and difficult to design. On the other hand, a de-interlacing method which requires less than three fields of pixels with known values for approximating values of missing pixels would translate to a significant savings of resources required for de-interlacing. A method requiring input information from two, instead of three, fields of pixels with known values would require measurably less data processing resources including hardware, software, memory, and calculation time. Moreover, since an de-interlacing processed by a three-field VT filter will first arrange the required fields in proper order before processing, echoes that forms unwanted false profiles outlining the moving objects are generally at the back of the moving object. But for an de-interlacing processed by a two-field VT filter, echoes can only be seen either in front or at the back of the moving object, so that the echoes of the two-field VT de-interlacing is considered easier to be detected while comparing to that of the e three-field VT de-interlacing. It is noted that the vertical temporal filer used in the present invention is a two-filed vertical temporal filter, comprising a spatial low-pass filter of two-tap design and a temporal high-pass filter. Please refer to FIG. 3, which illustrates a two-filed vertical temporal filter comprising a spatial low-pass filter of two-tap design and a temporal high-pass filter according to the present invention. In FIG. 3, it appear that the order of the two fields applied by the VT filter is irrelevant. The vertical position is indicated on the vertical axis, while the field number is indicated on the horizontal axis. The black dots P2, P3, . . . , P6, as well as P2′, . . . , P6′, indicate original samples while the open circle P1, as well as P1′, indicates an interpolated sample to be obtained. As seen in FIG. 3, the missing pixel represented by the open circle P1 or P1′ is derived from the two spatial neighbors P5, P6, or P2′, P3′, and the three temporal neighbors P2, P3, P5, or P4′, P5′, P6′, that is,

$$P 1 = \{ [ P 2 \times ( - 5 ) + P 3 \times 10 + P 4 \times ( - 5 ) ] + \frac{1}{16} [ P 5 \times 8 + P 6 \times 8 ] \} , \\ or$$

$$P {1}^{′} = \{ [ P {4}^{′} \times ( - 5 ) + P {5}^{′} \times 10 + P {6}^{′} \times ( - 5 ) ] + \frac{1}{16} [ P 2 \times 8 + P 3 \times 8 ] \} .$$

As the interlaced video signal is de-interlaced by a specific two-filed VT filter, the edge adaptive compensation stage 22 is being applied, wherein a process of edge adaptive compensation is being performed on the filtered video signal so as to adaptively compensate the interpolated pixel with respect to the detection of edges adjacent thereto and thus obtain an edge-compensated video signal.

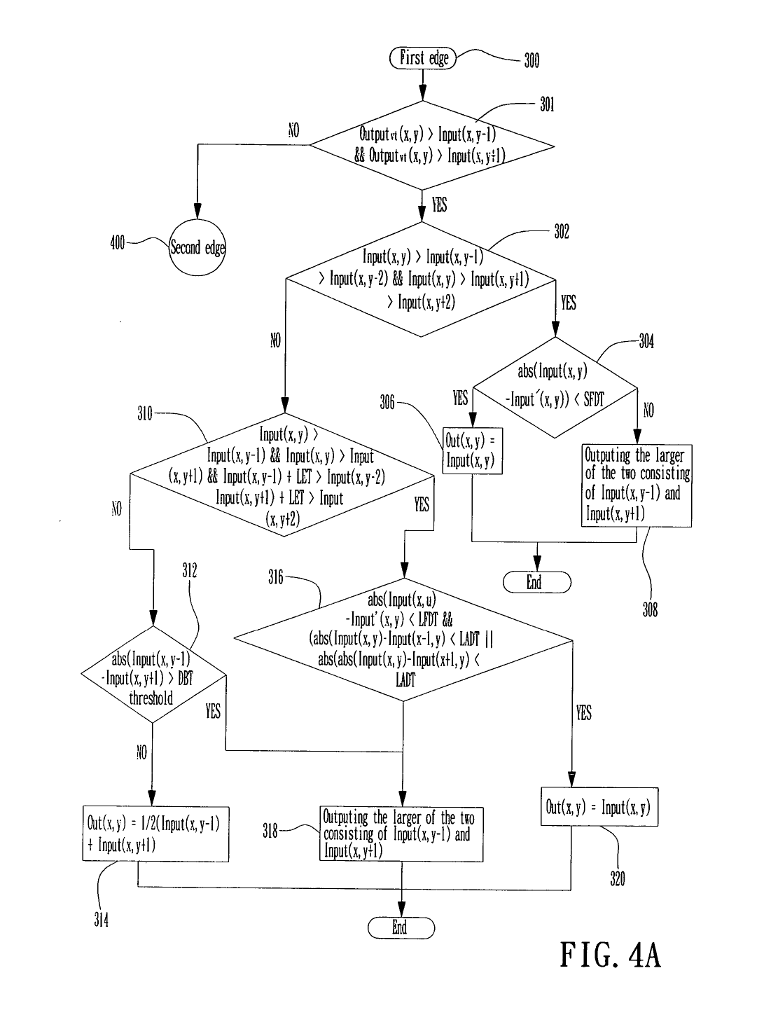

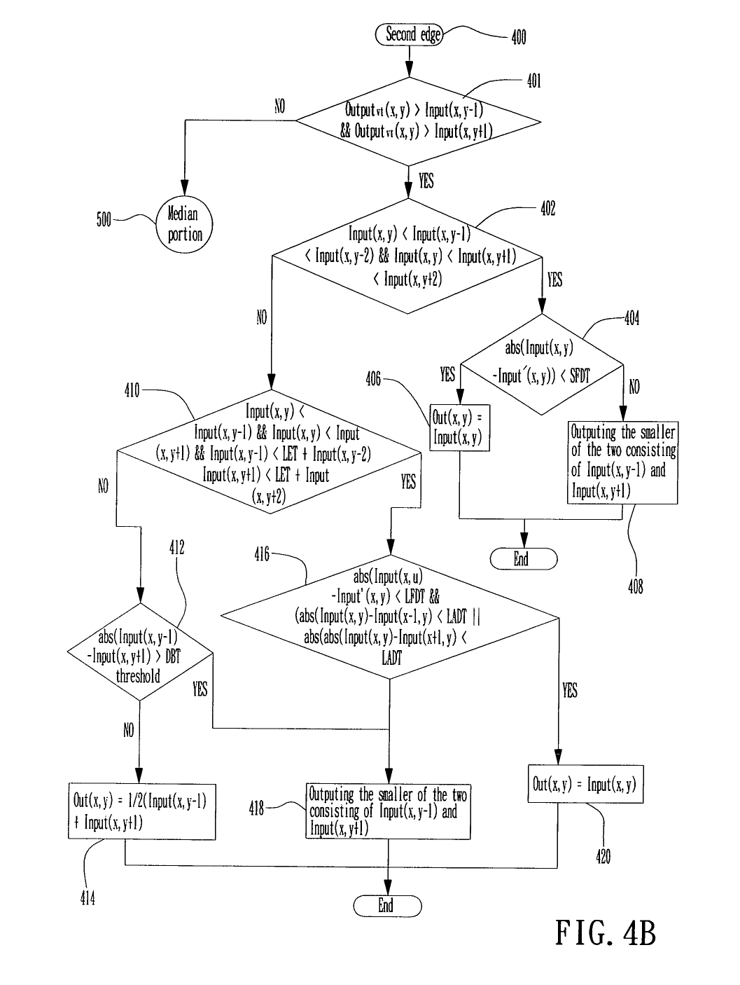

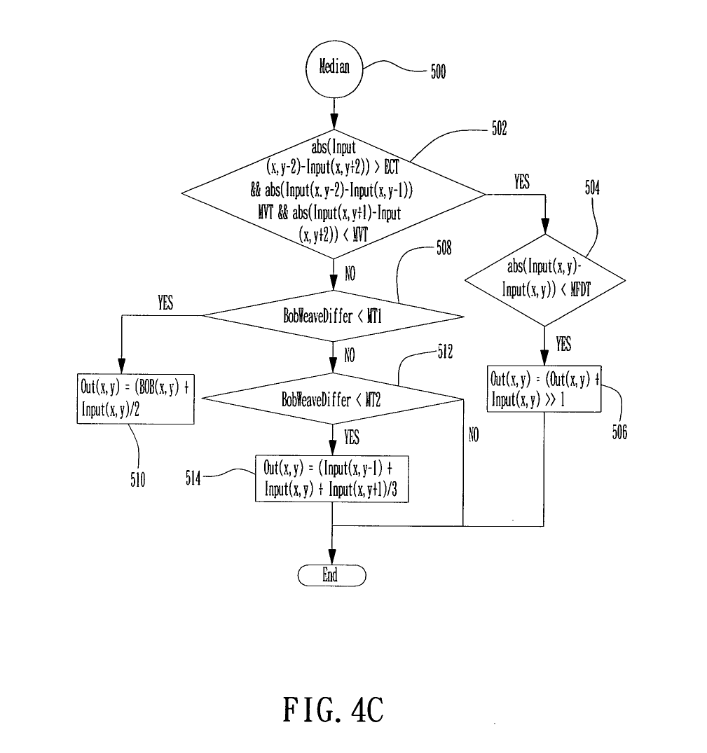

For clarity, hereinafter, pixels in the current field is identified using a two dimensional coordinate system, i.e. X axis being used as the horizontal coordinate while Y axis being used as the vertical coordinate, so that the value of a pixel at (x, y) location of the VT-filtered current field is denoted as Outputᵥₜ(x, y) while the original input value of the pixel at (x, y) location is denoted as Input(x, y), whereas BOB(x, y) represents the value of an Bob operation applied on the (x, y) location of the current field. Please refer to FIG. 4A to FIG. 4C, which illustrate a flowchart depicting a process of edge adaptive compensation of the adaptive vertical temporal filtering method according to a preferred embodiment of the present invention. The flow starts at a sun-flowchart 300 for classifying a first edge and proceeds to step 301. At step 301, an evaluation is being made to determine whether an interpolated pixel is classified as a first edge, that is,
Outputᵥₜ(x.y)>Input(x, y−1) & & Outputᵥₜ(x.y)>Input(x, y+1);
if so, the flow proceed to step 302; otherwise, the flow proceeds to a sub-flowchart 400 for classifying a second edge. At step 302, an evaluation is being made to determine whether the interpolated pixel classified as the first edge is a strong edge, that is,
Input(x.y)>Input(x, y−1)>Input(x, y−2) & &
Input(x.y)>Input(x, y+1)>Input(x, y+1);
if so, the interpolated pixel of first edge is classified as strong edge and the flow proceeds to step 304; otherwise, the interpolated pixel of first edge is classified as weak edge and the flow proceeds to step 310. At step 304, an evaluation is being made to determine whether the absolute difference of the original input data, i.e. Input(x, y), and a corresponding pixel positioned at the same location of an adjacent frame, being denoted as Input′(x, y), is smaller than a first threshold represented as SFDT; if so, the flow proceeds to step 306; otherwise, the flow proceeds to step 308. At step 306, the value of the interpolated pixel is replaced by Input(x, y). At step 308, the value of the interpolated pixel is replace by a larger value selected from the group of (Input(x, y−1), Input(x, y+1)).

At step 310, an evaluation is being made to determine whether a first condition of:
Input(x.y)>Input(x, y−1) & & Input(x.y)>Input(x, y+1) & &
Input(x.y−1)+LET>Input(x.y−2) & & Input(x.y+1)+LET>Input(x.y+2)
is satisfied; wherein LET represents the value of a second threshold; if so, the flow proceeds to step 316; otherwise, the flow proceeds to step 312. At step 312, an evaluation is being made to determine whether the absolute difference of Input(x, y−1) and Input(x, y+1) is larger than a third threshold represented as DBT; if so, the flow proceeds to step 318; otherwise, the flow proceeds to step 314. At step 314, the value of the interpolated pixel is replace by a value of Bob operation, that is, the sum of ½ Input(x.y−1) and ½ Input(x.y+1). At step 316, an evaluation is being made to determine whether the absolute difference of Input(x, y) and the corresponding pixel is smaller than a fourth threshold represented as LFDT and the absolute difference of Input(x, y) and any of the two horizontal neighboring pixels is small than a fifth threshold represented as LADT; if so, the flow proceeds to step 318; otherwise, the flow proceeds to step 320. At step 318, the value of the interpolated pixel is replace by a larger value selected from the group of (Input(x, y−1), Input(x, y+1)). At step 320, the value of the interpolated pixel is replaced by Input(x, y).

As the interpolated pixel fail to be classified as the first edge at step 301, the flow proceeds to the sub-flowchart 400 proceeding to step 401. At step 401, an evaluation is being made to determine whether an interpolated pixel is classified as a second edge, that is,
Outputᵥₜ(x.y)<Input(x, y−1) & & Outputᵥₜ(x.y)<Input(x, y+1)
if so, the flow proceed to step 402; otherwise, the flow proceeds to a sub-flowchart 500 for classifying a median portion. At step 402, an evaluation is being made to determine whether the interpolated pixel classified as the second edge is a strong edge, that is,
Input(x.y)<Input(x, y−1)<Input(x, y−2) & &
Input(x.y)<Input(x, y+1)<Input(x, y+1),
if so, the interpolated pixel of first edge is classified as strong edge and the flow proceeds to step 404; otherwise, the interpolated pixel of first edge is classified as weak edge and the flow proceeds to step 410. At step 404, an evaluation is being made to determine whether the absolute difference of original input data, i.e. Input(x, y), and a corresponding pixel positioned at the same location of an adjacent frame, being denoted as Input′(x, y), is smaller than the SFDT; if so, the flow proceeds to step 406; otherwise, the flow proceeds to step 408. At step 406, the value of the interpolated pixel is replaced by Input(x, y). At step 408, the value of the interpolated pixel is replace by a smaller value selected from the group of (Input(x, y−1), Input(x, y+1)).

At step 410, an evaluation is being made to determine whether a second condition of:
Input(x.y)<Input(x, y−1) & & Input(x.y)<Input(x, y+1) & &
Input(x.y−1)<LET+Input(x.y−2) & & Input(x.y+1)<LET+Input(x.y+2)
Input(x.y)>Input(x, y−1) & & Input(x.y)>Input(x, y+1) & &
Input(x.y−1)+LET>Input(x.y−2) & & Input(x.y+1)+LET>Input(x.y+2)
is satisfied; wherein LET represents the second threshold; if so, the flow proceeds to step 416; otherwise, the flow proceeds to step 412. At step 412, an evaluation is being made to determine whether the absolute difference of Input(x, y−1) and Input(x, y+1) is larger than the DBT; if so, the flow proceeds to step 418; otherwise, the flow proceeds to step 414. At step 414, the value of the interpolated pixel is replace by a value of Bob operation, that is, the sum of ½ Input(x.y−1) and ½ Input(x.y+1). At step 416, an evaluation is being made to determine whether the absolute difference of original input data, i.e. Input(x, y), and a corresponding pixel positioned at the same location of an adjacent frame, being denoted as Input′(x, y), is smaller than the LFDT and the absolute difference of Input(x, y) and any of the two horizontal neighboring pixels is smaller than the LADT; if so, the flow proceeds to step 418; otherwise, the flow proceeds to step 420. At step 418, the value of the interpolated pixel is replace by a smaller value selected from the group of (Input(x, y−1), Input(x, y+1)). At step 420, the value of the interpolated pixel is replaced by Input(x, y).

As the interpolated pixel fail to be classified as the second edge at step 401, the flow proceeds to the sub-flowchart 500 proceeding to step 502. At step 502, an evaluation is being made to determine whether a third condition of:
abs(Input(x, y−2)−Input(x, y+2))>ECT & &
abs(Input(x, y−2)−Input(x, y−1))>MVT & & is satisfied,
abs(Input(x, y+1)−Input(x, y+2))>MVT
whereas ECT is the value of a sixth threshold;
   MVT is the value of a seventh threshold;
      If so, the flow proceeds to step 504; otherwise, the flow proceeds to step 508. At step 504, an evaluation is being made to determine whether the absolute difference of the interpolated pixel and the corresponding pixel of an adjacent field next to the current field is small than a tenth threshold represented as SFDT; if so, the flow proceeds to step 506. At step 506, the interpolated pixel is replaced by the sum of half the value of the interpolated pixel and half of the value of the corresponding pixel of an adjacent field next to the current field. At step 508, a parameter referred as BobWeaveDiffer is defined to be the absolute difference between BOB(x, y) and Input(x, y) while making an evaluation to determine whether the BobWeaveDiffer is smaller than a eighth threshold represented as MT1; if so, the flow proceeds to step 510; otherwise, the flow proceeds to step 512. At step 510, the interpolated pixel is replaced by the sum of ½ BOB(x.y) and ½ Input(x.y). At step 512, an evaluation is being made to determine whether the BobWeaveDiffer is smaller than a ninth threshold represented as MT2; if so, the flow proceeds to step 514; otherwise, the interpolated pixel is maintained. At step 514, the interpolated pixel is replaced by the sum of ⅓ Input(x.y−1), ⅓ Input(x.y), and ⅓ Input(x.y+1).

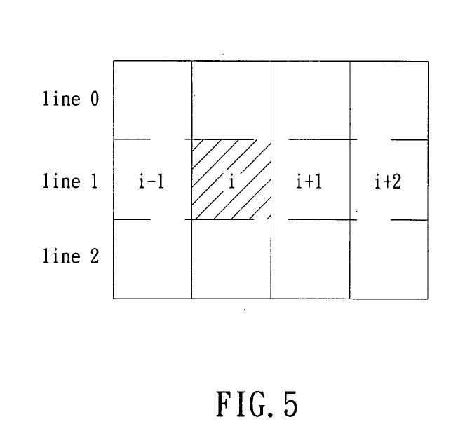

Please refer to FIG. 5, which is a schematic diagram illustrating a process unit of the noise reduction process according to the present invention. After applying the aforesaid process of edge adaptive compensation on the current field with respect to a adjacent filed, each pixel of the interpolated and edge-compensated current filed is subject to a process of noise reduction that each pixel is subjected to an evaluation to determine whether its is a noise according to specific thresholds designed corresponding to a specific high frequency data. For clarity, the value of the i-th pixel at a line referred as Line 1 is addressed as Lines[1][i]. In a preferred embodiment of the invention, the specific high frequency data can be acquired as following:
HorHF2_{—}02=abs(Line[1][i−1]−Line[1][i+1]); (Eq. 1)
HorHF2_{—}03=abs(Line[1][i−1]−Line[1][i+2]); (Eq. 2)
HorHF3_{—}012=abs(Line[1][i−1]+Line[1][i+1]−2×Line[1][i]); (Eq. 3)
HorHF2_{—}13=abs(Line[1][i−1]+Line[1][i+2]−2×Line[1][i]); (Eq. 4)
CurrVerHF2=abs(Line[0][i]−Line[2][i]); (Eq. 5)
CurrVerHF3=abs(Line[0][i]+Line[2][i]−2×Line[1][i]); (Eq. 6)
NextVerHF2=abs(Line[0][i+1]−Line[2][i]); (Eq. 7)
NextVerHF3=abs(Line[0][i+1]+Line[2][i+1]−2×Line[1][i+1]) (Eq. 8)

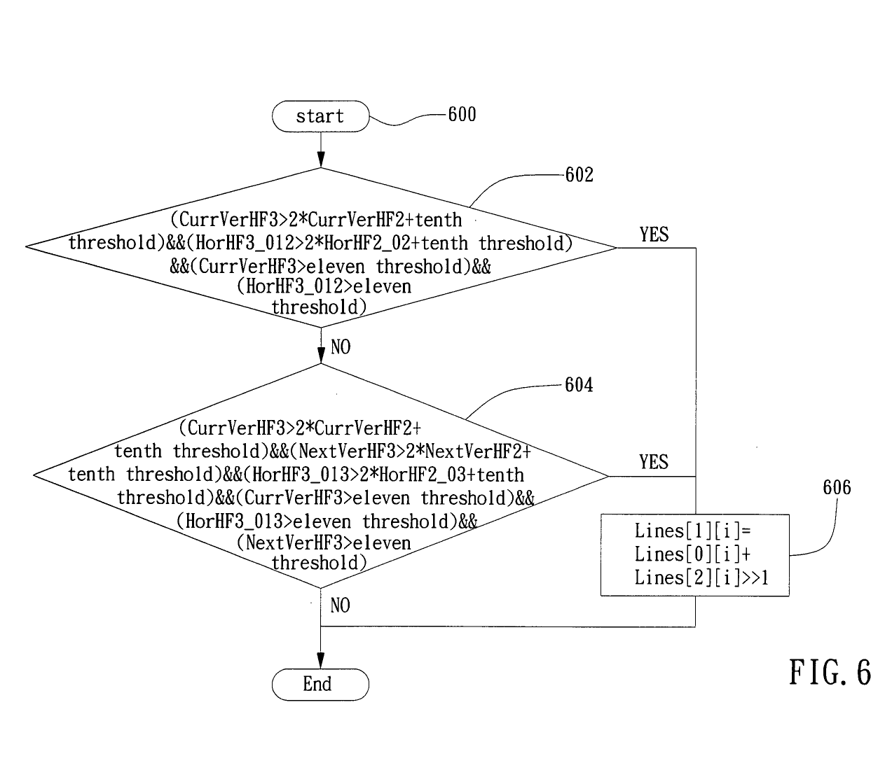

Please refer to FIG. 6, which is a flowchart illustrating the noise reduction process on the edge-compensated result according to the present invention. The flow starts at the step 600 and proceeds to step 602. At step 602, an evaluation is being made to determine whether a fourth condition of:
(CurrVerHF3>2×CurrVerHF2+HDT) & &
(HorHF3_{—}012>2×HorHF2_{—}02+HDT) & &
(CurrVerHF3>HT) & &
(HorHF3_{—}012>HT)
whereas HDT is the value of a eleventh threshold;
   HT is the value of a twelfth threshold.
      is satisfied; if so, the flow proceeds to step 606; otherwise, the flow proceeds to step 604. At step 606, the value of a current pixel represented as Lines[1][I] is replaced by the result of a BOB operation, that is, let Lines[1][i]=½ Lines[0][i]+½ Lines[2][i]. At step 604, an evaluation is being made to determine whether a fifth condition of:
      (CurrVerHF3>2×CurrVerHF2+HDT) & &
      (NextVerHF3>2×NextVerHF2+HDT) & &
      (HorHF3_{—}013>2×HorHF2_{—}03+HDT) & &
      (CurrVerHF3>HT) & &
      (HorHF3_{—}013>HT) & &
      (NextVerHF3>HT)
      is satisfied; if so, the flow proceeds to step 606; otherwise the value of the current pixel is maintained.

It is noted that other prior-art de-interlacing methods can be performed cooperatively with the adaptive vertical temporal filtering method of de-interlacing of the present invention.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An adaptive vertical temporal filtering method of de-interlacing, comprising the steps of:
performing a process of VT filtering on an interlaced video signal to obtain a filtered video signal;
performing a process of edge adaptive compensation on the filtered video signal to obtain an edge-compensated video signal;
performing a process of noise reduction on the edge-compensated video signal.

2. The method of claim 1, wherein the process of VT filtering further comprise the step of: interpolating a missing pixel of a current field of the interlaced video signal by using a vertical temporal filter and thereby obtaining an interpolated pixel, in addition, for clarity, pixels in the current field is identified using a two dimensional coordinate system, i.e. X axis being used as the horizontal coordinate while Y axis being used as the vertical coordinate, so that the value of a pixel at (x, y) location of the VT-filtered current field is denoted as Outputᵥₜ(x, y) while the original input value of the pixel at (x, y) is denoted as Input(x, y).

3. The method of claim 2, wherein the vertical temporal filer is a filter selected from the group consisting of a two-field vertical temporal filter and a three-field vertical temporal filter, each comprising a spatial low-pass filter of two-tap design and a temporal high-pass filter.

4. The method of claim 2, wherein the process of edge adaptive compensation further comprises the steps of:
making an evaluation to determine whether the interpolated pixel is classified as a first edge with respect to vertical neighboring pixels;
making an evaluation to determine whether the interpolated pixel is classified as a second edge with respect to vertical neighboring pixels;
making an evaluation to determine whether the interpolated pixel is classified as a median portion;
making an evaluation to determine whether the interpolated pixel classified as the first edge is a strong edge;
making an evaluation to determine whether the interpolated pixel classified as the first edge is a weak edge;
making an evaluation to determine whether the interpolated pixel classified as the second edge is the strong edge;
making an evaluation to determine whether the interpolated pixel classified as the second edge is the weak edge;
performing a first strong compensation process on the interpolated pixel classified as the first and the strong edge;
performing a second strong compensation process on the interpolated pixel classified as the second and the strong edge;
performing a first weak compensation process on the interpolated pixel classified as the first and the weak edge;
performing a second weak compensation process on the interpolated pixel classified as the second and the weak edge; and
performing an conservative compensation process on the interpolated pixel classified as median portion.

5. The method of claim 4, wherein the first strong compensation process further comprises the steps of:
classifying an interpolated pixel at (x, y) position as the first edge while Input (x, y) satisfies the condition of:
Outputᵥₜ(x.y)>Input(x, y−1) & & Outputᵥₜ(x.y)>Input(x, y+1)
classifying the interpolated pixel of first edge as the strong edge while Input (x,y) satisfies the condition of:
Input(x.y)>Input(x, y−1)>Input(x, y−2) & &;
Input(x.y)>Input(x, y+1)>Input(x, y+1);
comparing the original input value of the pixel at (x, y) location, i.e. Input(x, y), to a corresponding pixel positioned at the same location of an adjacent frame, being denoted as Input′(x, y);
replacing the interpolated pixel by Input(x, y) while the absolute difference of Input(x, y) and Input′(x, y) is smaller than a first threshold represented as SFDT; and
replacing the interpolated pixel with a larger value selected from the group of (Input(x, y−1), Input(x, y+1)) while the absolute difference of Input(x, y) and Input′(x, y) is not smaller than a first threshold represented as SFDT.

6. The method of claim 4, wherein the second strong compensation process further comprises the steps of:
classifying an interpolated pixel as the second edge while Input (x, y) satisfies the condition of:
Outputᵥₜ(x.y)<Input(x, y−1) & & Outputᵥₜ(x.y)<Input(x, y+1);
classifying the interpolated pixel of second edge as the strong edge while Input (x,y) satisfies the condition of:
Input(x.y)<Input(x, y−1)<Input(x, y−2) & &
Input(x.y)<Input(x, y+1)<Input(x, y+1)
comparing the original input value of the pixel at (x, y) location, i.e. Input(x, y), to a corresponding pixel positioned at the same location of an adjacent frame, being denoted as Input′(x, y);
replacing the interpolated pixel by Input(x, y) while the absolute difference of Input(x, y) and Input′(x, y) is smaller than a first threshold represented as SFDT; and
replacing the interpolated pixel with a smaller value selected from the group of (Input(x, y−1), Input(x, y+1)) while the absolute difference of Input(x, y) and Input′(x, y) is not smaller than a first threshold represented as SFDT.

7. The method of claim 5, wherein the first weak compensation process further comprises the steps of: classifying the interpolated pixel of fist edge as the weak edge while the condition of:
Input(x.y)>Input(x, y−1)>Input(x, y−2) & &
Input(x.y)>Input(x, y+1)>Input(x, y+1)
is not satisfied;
making an evaluation to determine whether a first condition of:
Input(x.y)>Input(x, y−1) & & Input(x.y)>Input(x, y+1) & &
Input(x.y−1)+LET>Input(x.y−2) & & Input(x.y+1)+LET>Input(x.y+2)
is satisfied; wherein LET represents the value of a second threshold;
making an evaluation to determine whether the absolute difference of Input(x, y−1) and Input(x, y+1) is larger than a third threshold represented as DBT while the first condition is not satisfied;
replacing the interpolated pixel with a value of the sum of ½ Input(x.y−1) and ½ Input(x.y+1) while the absolute difference of Input(x, y−1) and Input(x, y+1) is not larger than the DBT as the first condition is not satisfied;
replacing the interpolated pixel with a larger value selected from the group of (Input(x, y−1), Input(x, y+1)) while the absolute difference of Input(x, y−1) and Input(x, y+1) is larger than the DBT as the first condition is not satisfied;
comparing the original input value of the pixel at (x, y) location, i.e. Input(x, y), to a corresponding pixel positioned at the same location of an adjacent frame, being denoted as Input′(x, y), and simultaneously to both of the two horizontal neighboring pixels while the first condition is satisfied;
replacing the interpolated pixel with a larger value selected from the group of (Input(x, y−1), Input(x, y+1)) while the absolute difference of Input(x, y) and Input′(x, y) is not smaller than a fourth threshold represented as LFDT and the absolute difference of Input(x, y) and any of the two horizontal neighboring pixels is not smaller than a fifth threshold represented as LADT as the first condition is satisfied; and
replacing the interpolated pixel by Input(x, y) while the absolute difference of Input(x, y) and Input′(x, y) is smaller than the LFDT and the absolute difference of Input(x, y) and any of the two horizontal neighboring pixels is smaller than the LADT as the first condition is satisfied.

8. The method of claim 6, wherein the second weak compensation process further comprises the steps of:
classifying the interpolated pixel of fist edge as the weak edge while the condition of:
Input(x.y)<Input(x, y−1)<Input(x, y−2) & &
Input(x.y)<Input(x, y+1)<Input(x, y+1)
is not satisfied;
making an evaluation to determine whether a second condition of:
Input(x.y)<Input(x, y−1) & & Input(x.y)<Input(x, y+1) & &
Input(x.y−1)<LET+Input(x.y−2) & & Input(x.y+1)<LET+Input(x.y+2)
is satisfied; wherein LET represents the value of the second threshold;
making an evaluation to determine whether the absolute difference of Input(x, y−1) and Input(x, y+1) is larger than the third threshold represented as DBT while the second condition is not satisfied;
replacing the interpolated pixel with a value of the sum of ½ Input(x.y−1) and ½ Input(x.y+1) while the absolute difference of Input(x, y−1) and Input(x, y+1) is not larger than the DBT as the second condition is not satisfied;
replacing the interpolated pixel with a smaller value selected from the group of (Input(x, y−1), Input(x, y+1)) while the absolute difference of Input(x, y−1) and Input(x, y+1) is larger than the DBT as the second condition is not satisfied;
comparing the original input value of the pixel at (x, y) location, i.e. Input(x, y), to a corresponding pixel positioned at the same location of an adjacent frame, being denoted as Input′(x, y), and simultaneously to both of the two horizontal neighboring pixels while the second condition is satisfied;
replacing the interpolated pixel with a smaller value selected from the group of (Input(x, y−1), Input(x, y+1)) while the absolute difference of Input(x, y) and Input′(x, y) is not smaller than the fourth threshold represented as LFDT and the absolute difference of Input(x, y) and any of the two horizontal neighboring pixels is not smaller than the fifth threshold represented as LADT as the second condition is satisfied; and
replacing the interpolated pixel by Input(x, y) while the absolute difference of Input(x, y) and Input′(x, y) is smaller than the LFDT and the absolute difference of Input(x, y) and any of the two horizontal neighboring pixels is small than the LADT as the second condition is satisfied.

9. The method of claim 4, wherein BOB(x, y) represents the value of an Bob operation applied on the (x, y) location of the current field and the conservative compensation process further comprises the steps of:
classifying the interpolated pixel as the median portion while the condition of:
Input(x.y)>Input(x, y−1) & & Input(x.y)>Input(x, y+1)
and
Input(x.y)<Input(x, y−1) & & Input(x.y)<Input(x, y+1) is not satisfied;
making an evaluation to determine whether a third condition of:
abs(Input(x, y−2)−Input(x, y+2))>ECT & &
abs(Input(x, y−2)−Input(x, y−1))>MVT & & is satisfied;
abs(Input(x, y+1)−Input(x, y+2))>MVT
where ECT is the value of a sixth threshold
MVT is the value of a seventh threshold
comparing the original input value of the pixel at (x, y) location, i.e. Input(x, y), to a corresponding pixel positioned at the same location of an adjacent frame, being denoted as Input′(x, y), while the third condition is satisfied;
replacing the interpolated pixel with the sum of half the value of the interpolated pixel and half of the value of the corresponding pixel of an adjacent field next to the current field while the absolute difference of Input(x, y) and Input′(x, y) is smaller than a tenth threshold represented as MFDT as the third condition is satisfied;
maintaining the interpolated pixel while the absolute difference of Input(x, y) and Input′(x, y) is not small than a tenth threshold represented as MFDT as the third condition is satisfied;
calculating a parameter referred as BobWeaveDiffer to be the absolute difference between BOB(x, y) and Input(x, y) while the third condition is not satisfied;
comparing the BobWeaveDiffer to a eighth threshold represented as MT1;
replacing the interpolated pixel with the sum of ½ BOB(x.y) and ½ Input(x.y) while the BobWeaveDiffer is smaller than the MT1;
comparing the BobWeaveDiffer to a ninth threshold represented as MT2 while the BobWeaveDiffer is not smaller than the MT1;
replacing the interpolated pixel with the sum of ⅓ Input(x.y−1), ⅓ Input(x.y), and ⅓ Input(x.y+1) while the BobWeaveDiffer is smaller than the MT2 as the BobWeaveDiffer is not smaller than the MT1; and
maintaining the interpolated pixel while the BobWeaveDiffer is not smaller than the MT2 as the BobWeaveDiffer is not smaller than the MT1;

10. The method of claim 1, wherein the process of noise reduction further comprises the steps of:
making an evaluation to determine whether the interpolated pixel is abrupt with respect to its neighboring pixels; and
replacing the interpolated pixel with the value of a Bob operation performed on the neighboring pixels of the interpolated pixel on the current field while the interpolated pixel is abrupt.

11. The method of claim 1, other prior-art de-interlacing methods can be performed cooperatively with the adaptive vertical temporal filtering method of de-interlacing.
